(19) United States
(12) Patent Application Publication
(10) Pub. No.: US 2007/0091224 A1
(43) Pub. Date: Apr. 26, 2007

(54) Liquid crystal display having frame with antiskid member integrally formed thereon

(75) Inventor: Kuan-Ting Liu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/584,881

(22) Filed: Oct. 23, 2006

(30) Foreign Application Priority Data
Oct. 21, 2005 (TW) 94136996

(51) Int. Cl. G02F 1/1333

(52) U.S. Cl. 349/58

(57) ABSTRACT

An exemplary liquid crystal display (1) includes a frame (15) and a liquid crystal panel (10). The frame includes a supporting board (150); and an antiskid member (153) integrally formed with and directly joined to the supporting board. The liquid crystal panel is received in the frame, and edge portions of the liquid crystal panel contact the antiskid member.

### FIELD OF THE INVENTION

The present invention relates to liquid crystal displays (LCDs), and more particularly to a liquid crystal display which includes a frame having an antiskid member integrally formed thereon.

### GENERAL BACKGROUND

Liquid crystal displays are commonly used as display devices for compact electronic apparatuses, because they not only provide good quality images but are also very thin.

Referring to FIG. 3, a typical liquid crystal display 3 includes a liquid crystal panel 30, a first brightness enhancement film (BEF) 31, a second BEF 32, a diffusing film 33, and a light guide plate (LGP) 34, arranged in that order from top to bottom. The liquid crystal display 3 further includes four light emitting diodes 36 disposed adjacent to a light incident surface 342 of the light guide plate 34, and a frame 35. The frame 35 includes a supporting board 352, which defines a space (not labeled) for accommodating the first BEF 31, the second BEF 32, the diffusing film 33, and the light guide plate 34. The liquid crystal panel 30 is also received in the frame 35 such that it is supported on the supporting board 352. The supporting board 352 includes a plurality of flat top surfaces 354. The frame 35 is in general made from plastic.

When the liquid crystal display 3 is assembled, the liquid crystal panel 30, the first BEF 31, the second BEF 32, the diffusing film 33, the light guide plate 34, and the light emitting diodes 36 are received in the frame 35. Edge portions (not labeled) of the liquid crystal panel 30 contact the top surfaces 354 of the supporting board 352 respectively. Because there is generally little friction between the edge portions of the liquid crystal panel 30 and the top surfaces 354 of the supporting board 352, the liquid crystal panel 30 is liable to slide on the supporting board 352. Therefore when the liquid crystal display 3 is subjected to vibration or shock during operation or transportation, a bottom glass substrate (not labeled) of the liquid crystal panel 30 is liable to shift, and a bottom glass substrate (not labeled) of the liquid crystal panel 30 may be scraped. When this happens, the optical performance of the liquid crystal display 3 may be impaired.

Referring to FIG. 4, another typical liquid crystal display 4 employs an antiskid adhesive film 47 disposed on top surfaces 454 of a supporting board 452 of a frame 45. The antiskid adhesive film 47 is located between a liquid crystal panel 40 and the top surfaces 454 of the supporting board 452. Therefore the antiskid adhesive film 47 may prevent the liquid crystal panel 40 from sliding and sustaining scraping. However, in assembly of the liquid crystal display 4, a step of aligning and attaching the antiskid adhesive film 47 to the top surfaces 454 of the supporting board 452 is needed. The step is typically performed by manual labor, and adds to the cost of manufacturing the liquid crystal display 4.

What is needed, therefore, is a liquid crystal display that can overcome the above-described deficiencies.

### SUMMARY

In a preferred embodiment, a liquid crystal display includes a frame and a liquid crystal panel. The frame includes a supporting board, and an antiskid member integrally formed with and directly joined to the supporting board. The liquid crystal panel is received in the frame, and edge portions of the liquid crystal panel contact the antiskid member.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, isometric view of an exemplary embodiment of a liquid crystal display of the present invention.

FIG. 2 is an assembled view of the liquid crystal display of FIG. 1.

FIG. 3 is an exploded, isometric view of a conventional liquid crystal display.

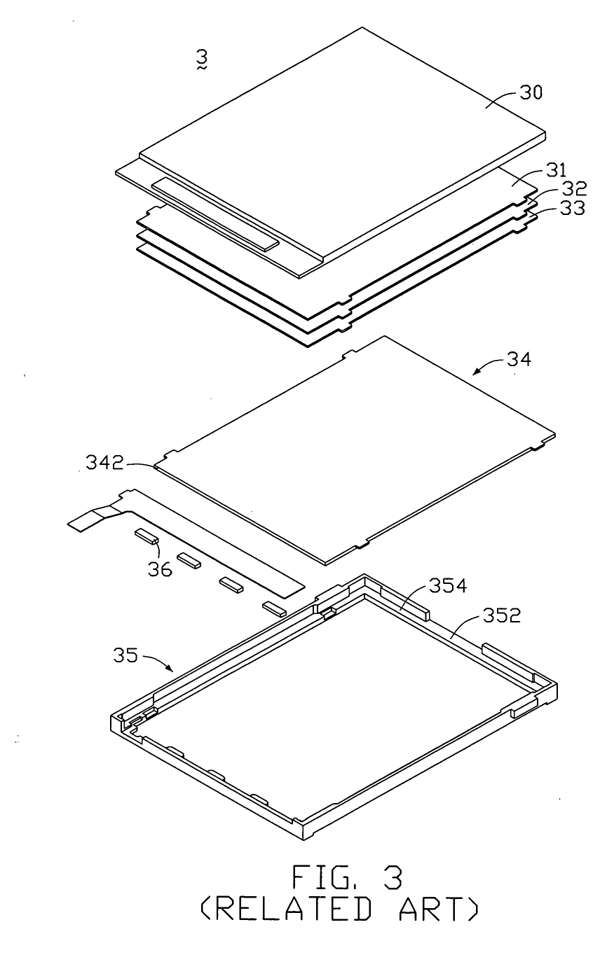

FIG. 4 is an exploded, isometric view of another conventional liquid crystal display.

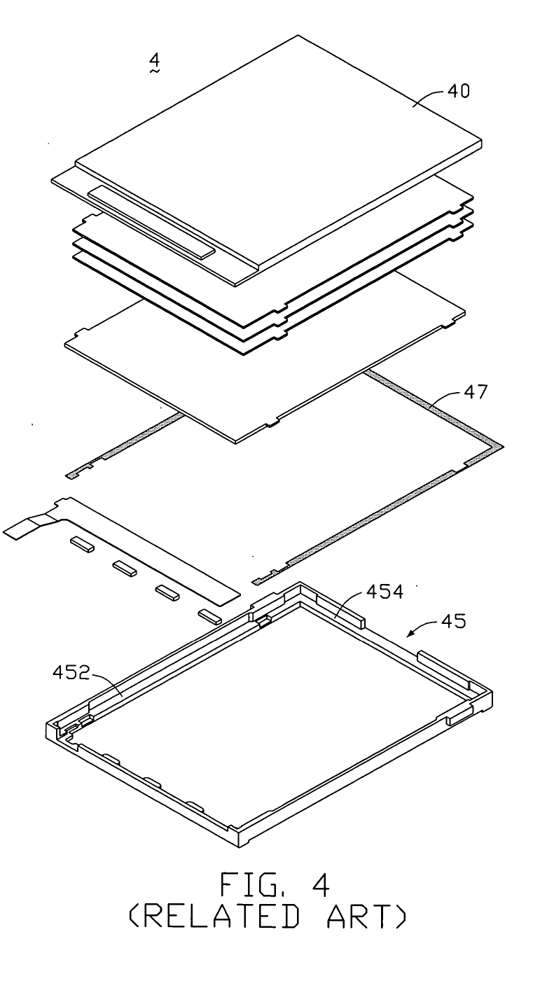

### DETAILED DESCRIPTION OF PREFERRED EMBODIMENTS

Reference will now be made to the drawings to describe the preferred embodiments in detail.

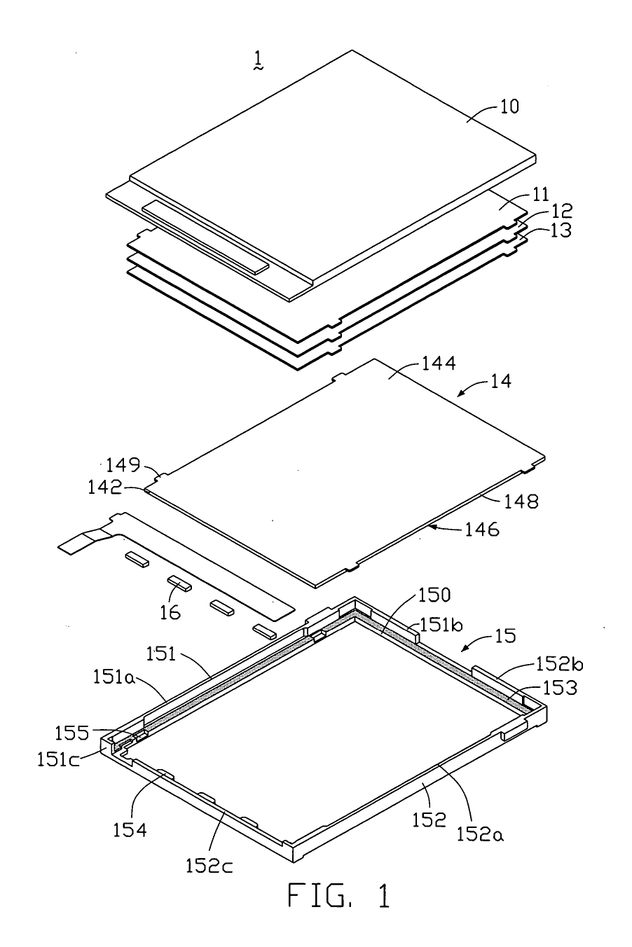

Referring to FIG. 1, a liquid crystal display 1 of an exemplary embodiment of the present invention is shown. The liquid crystal display 1 includes a liquid crystal panel 10, a first BEF 1, a second BEF 12, a diffusing film 13, and a light guide plate 14, arranged in that order from top to bottom. The liquid crystal display 1 further includes a frame 15, and a plurality of light emitting diodes 16 located adjacent to a light incident surface 142 of the light guide plate 14. In the illustrated embodiment, there are four light emitting diodes 16, which cooperatively serve as a light source. The liquid crystal panel 10, the first BEF 11, the second BEF 12, the diffusing film 13, the light guide plate 14, and the light emitting diodes 16 are received in the frame 15.

The light guide plate 14 includes the light incident surface 142, a light emitting surface 144 perpendicularly connecting with the light incident surface 142, a bottom surface 146 opposite to the light emitting surface 144, and two opposite side surfaces 148 connecting with the light incident surface 142. The side surfaces 148 are between the light emitting surface 144 and the bottom surface 146. The diffusing film 13 is disposed adjacent to the light emitting surface 144 of the light guide plate 14. A pair of ears 149 outwardly extend from each side surface 148 respectively. The ears 149 are near end portions (not labeled) of the respective side surfaces 148. The light guide plate 14 can for example be made from polycarbonate (PC) or polymethyl methacrylate (PMMA), and can be manufactured by an injection molding method.

The frame 15 is generally rectangular. The frame 15 includes a supporting board 150, and a U-shaped first side wall 151 and a U-shaped second side wall 152 both connected with the supporting board 150. The supporting board 150 is generally a rectangular frame forming part of the frame 15. Portions of the supporting board 150 perpendicularly extend inward from inner surfaces (not labeled) of the first side wall 151 and the second side wall 152. Thus the supporting board 150 defines a rectangular space (not labeled) for accommodating the first BEF 11, the second BEF 12, the diffusing film 13, and the light guide plate 14. An antiskid layer 153 is integrally formed on all of top surfaces (not labeled) of the supporting board 150, with the antiskid layer 153 and the supporting board 150 being an integrated whole. That is, the antiskid layer 153 has a continuous configuration across the top surfaces of the supporting board 150. A plurality of protrusions 154 are formed along an inner surface (not labeled) of the supporting board 150 at one end of the frame 15. In the illustrated embodiment, there are three protrusions 154. The protrusions 154 are parallel to each other, extending into the space. The light emitting diodes 16 can be respectively disposed in a series of spaces defined between every two adjacent protrusions 154 and between endmost protrusions 154 and corresponding portions of the supporting board 150. The frame 15 further defines two pairs of notches 155 positioned at two opposite long inner sides (not labeled) of the supporting board 150 respectively. Each notch 155 corresponds to a respective one of the ears 149 of the light guide plate 14. That is, the ears 149 can be received in the notches 155 respectively. The antiskid layer 153 can be made from rubber such as natural rubber. The frame 15 is preferably made from white polycarbonate, plastic or any other suitable material. The frame 15 with the integrally formed antiskid layer 153 can be manufactured by a so-called double shot injection molding method. When this method is used, the antiskid layer 153 is directly joined to the frame 15. That is, the antiskid layer 153 is joined in immediate contact with the frame 15. No intervening material or joining means is needed for the antiskid layer 153 to be joined with the frame 15 to form an integrated whole.

The first side wall 151 has a generally asymmetrical U-shape, and includes a first arm 151a, a second arm 151b, and a third arm 151c. The first arm 151a extends along a corresponding first long side of the frame 15. The second arm 151b and the third arm 151c respectively extend along two opposite short sides of the frame 15. The second arm 151b is longer than the third arm 151c. The second side wall 152 has a generally asymmetrical U-shape, and includes a fourth arm 152a, a fifth arm 152b, and a sixth arm 152c. The fourth arm 152a extends along a corresponding second long side of the frame 15, and is parallel to and opposite from the first arm 151a. The fifth arm 152b and the sixth arm 152c respectively extend along the two opposite short sides of the frame 15. The sixth arm 152c is adjacent to the protrusions 154 of the supporting board 150, and is longer than the fifth arm 152b. The second arm 151b of the first side wall 151 is aligned with the fifth arm 152b of the second side wall 152. The third arm 151c of the first side wall 151 is aligned with the sixth arm 152c of the second side wall 152.

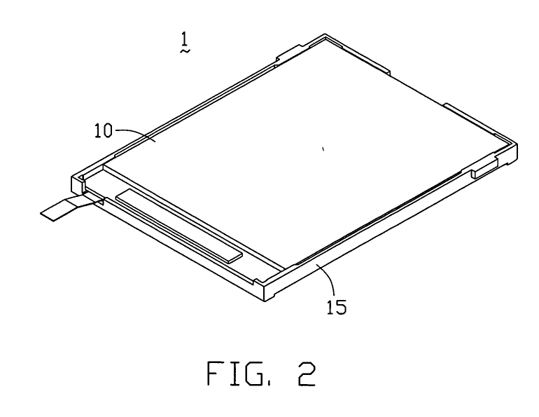

Referring also to FIG. 2, when the liquid crystal display 1 is assembled, the liquid crystal panel 10, the first BEF 11, the second BEF 12, the diffusing film 13, the light guide plate 14, and the light emitting diodes 16 are received in the frame 15. The ears 149 of the light guide plate 14 are received in the notches 155 of the frame 15 respectively. Edge portions of the liquid crystal panel 10 contact the antiskid layer 153 that is integrally formed with and directly joined to the supporting board 150.

Because the antiskid layer 153 is integrally formed on the frame 15, there is no need for a manufacturing step of aligning and attaching a separate antiskid member to the supporting board 150. Thereby, the efficiency of manufacturing the liquid crystal display 1 can be improved, and the cost of the liquid crystal display 1 can be reduced. In addition, the antiskid layer 153 helps prevent the liquid crystal panel 10 from sliding when the liquid crystal display 1 is subjected to vibration or shock during operation or transportation. Furthermore, when the antiskid layer 153 is made from natural rubber, even if sliding of the liquid crystal panel 10 occurs, scraping of the liquid crystal panel 10 is avoided. Thus, the liquid crystal display 1 can achieve optimized optical performance and reliability at a relatively low cost.

Further or alternative embodiments may include the following. In one example, the antiskid layer 153 can be made from another suitable material that can prevent the liquid crystal panel 10 from sliding and protect the liquid crystal panel 10 from being scraped. The material can be synthetic rubber. In another example, surfaces 148 of the light guide plate 14 between the light emitting surface 144 and the bottom surface 146 (except of course the light incident surface 142) can be coated with reflective material for improving a light utilization ratio of the liquid crystal display 1. In a further example, the antiskid layer 153 can be integrally formed on the top surfaces 154 but have a discontinuous configuration.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A liquid crystal display comprising:
a frame comprising:
a supporting board; and
an antiskid member integrally formed with and directly joined to the supporting board; and
a liquid crystal panel received in the frame, edge portions of the liquid crystal panel contacting the antiskid member.

2. The liquid crystal display in claim 1, wherein the antiskid member is formed on top surfaces of the supporting board.

3. The liquid crystal display in claim 1, wherein the antiskid member is continuously or discontinuously formed on the supporting board.

4. The liquid crystal display in claim 1, wherein the antiskid member is made from natural rubber or synthetic rubber.

5. The liquid crystal display in claim 1, wherein the antiskid member and the frame are integrally formed by a double shot injection molding method.

6. The liquid crystal display in claim 1, wherein the frame further comprises a first side wall and a second side wall extending from the supporting board.

7. The liquid crystal display in claim 6, wherein the supporting board is generally a rectangular frame portion of the frame.

8. The liquid crystal display in claim 7, wherein the supporting board perpendicularly extends inward from inner surfaces of the first side wall and the second side wall, whereby the frame defines a generally rectangular space for accommodating the liquid crystal panel.

9. The liquid crystal display in claim 1, wherein the supporting board and the antiskid member are an integrated whole.

10. The liquid crystal display in claim 1, wherein the frame is made from white polycarbonate or another kind of plastic.

11. A liquid crystal display comprising:
a liquid crystal panel;
a tray receiving the liquid crystal panel; and
an antiskid member integrally formed with and directly joined to the tray at one or more portions of the tray that support the liquid crystal panel, wherein the antiskid member is configured for preventing the liquid crystal panel from sliding in the tray.

12. The liquid crystal display in claim 1, wherein the antiskid member is continuously distributed at said one or more portions.

13. The liquid crystal display in claim 11, wherein the antiskid member is made from natural rubber or synthetic rubber.

14. The liquid crystal display in claim 11, wherein the antiskid member and the tray are integrally formed by a double shot injection molding method.

15. A liquid crystal display comprising:
a liquid crystal panel;
a tray receiving the liquid crystal panel; and
an antiskid member integrally is applied upon the tray and directly contacts the liquid crystal panel for preventing the liquid crystal panel from sliding upon the tray.

16. The liquid crystal display in claim 15, wherein the liquid crystal panel contacts the antiskid member in pressure.
